(19) United States
(12) Patent Application Publication
(10) Pub. No.: US 2012/0158565 A1
(43) Pub. Date: Jun. 21, 2012

(54) System and Method for Financial Budgeting

(76) Inventor: Mohammad Shakaib Iqbal, (US)

(21) Appl. No.: 13/328,922

(22) Filed: Dec. 16, 2011

Related U.S. Application Data
(60) Provisional application No. 61/424,030, filed on Dec. 16, 2010.

(51) Int. Cl. G06Q 40/02

(52) U.S. Cl. 705/35

(57) ABSTRACT

A systems, methods, and devices for enabling a credit holder to securely transmit credit data and set temporary credit limits, distinct from limits set by a lending institution, are provided. One embodiment of the method provides for encrypting credit data over a network through a multiple encryptions prior to enabling a user access to personally set credit limits.

### RELATED APPLICATION

This application claims priority from U.S. Provisional Patent Application Ser. No. 61/424,030, filed Dec. 16, 2010, which is incorporated herein by reference in its entirety for all purposes.

### FIELD OF THE INVENTION

The present invention relates generally to the field of systems and methods for processing credit card transactions. The present invention can be applied to any industry that uses processing systems.

### BACKGROUND OF THE INVENTION

A credit card is a vehicle for conducting a financial transaction, whereby it is most commonly represented by a plastic card. Credit cards are generally issued by a bank and provide a mechanism through which an authorized cardholder/consumer purchases products (e.g., goods, services) without an immediate, direct exchange of cash. The cardholder does not need to carry large amounts of cash with him/her because the card itself will suffice. With each purchase, a cardholder thereby incurs debt which he/she may thereafter (i.e., upon receipt of a monthly or otherwise periodic statement) fully pay the outstanding balance. Alternatively, the cardholder may, as a matter of necessity or choice, defer at least a portion of the balance for later payment with accompanying interest or finance charges for the period during which payment of the outstanding debt is deferred.

The spending power (i.e., the total amount of funds available to the cardholder at any particular time for making purchases and the like) of a credit card is typically limited to a particular amount (a “credit limit”) predetermined by the issuer of the card (i.e., the Bank). The amount of the issuer-imposed credit limit is generally based on a number of nonexclusive factors, the most important of which are often the cardholder's earning capacity, credit history, and ability to pay back the debt. When purchases are made or debts incurred with the credit card, the available portion of the credit limit is reduced by the purchase or debt amounts. In addition, interest and/or finance charges are also subtracted from the available portion of the credit limit on a periodic basis. The total debits on a credit card are typically referred to as the “outstanding balance,” while the remaining or available balance of the credit limit is typically called the “available balance” and reflects the dynamically adjusted current spending power of the credit card. The cardholder may increase the available balance, up to the credit limit, by paying to the issuer (or its representative) the entire outstanding balance or a fractional portion thereof.

Under most known credit card administration methods, the card issuer informs the cardholder of the credit limit associated with the credit card. In this way, the credit limit acts as a threshold above which the card issuer will not normally allow purchases by the cardholder. A cardholder may sometimes circumvent the credit limit by applying for a higher credit limit or by requesting and obtaining express authorization from the card issuer to make an emergency purchase above the credit limit. Both of these options are granted only at the discretion of the card issuer, generally on a case-by-case basis and may result in additional charges to the cardholder.

In a typical credit card administration scheme, transactions are approved via the interaction of a point-of-sale terminal and a central data processor. When a merchant attempts to debit a credit card account, the merchant's point-of-sale terminal sends an electronic message to the central data processor. The central data processor determines whether the potential transaction, if accepted, would cause the outstanding balance to exceed the credit limit. In other words, the central data processor determines whether the potential transaction is of a greater monetary value than the available balance. The central data processor also determines if the card issuer has placed some sort of hold or other block on further transactions. Additionally, the central data processor may also execute some anti-fraud algorithms to determine patterns of suspect buying behavior (e.g., those patterns indicating theft or fraud). If all of these tests are passed, then the central data processor may issue an approval to the point-of-sale terminal. The merchant then completes the transaction.

As mentioned above, although the cardholder is subject to the credit limit of his/her card, a vast majority of times the cardholder rarely exceeds or borrows amounts close to the credit limit. Often, the cardholder is aware of the use of the card (i.e. his/her spending habits) and is in tune with the transactions, either on a daily, weekly, monthly, quarterly, annually—or any other time period—basis. The “excess” or “unused” funds of the credit limit can be a potential liability to the cardholder and the issuer alike. For example, if a card with a very large credit limit (i.e. a “high value card”) is stolen, a significant number of transactions may occur before anti-fraud mechanisms put in place by the issuer invalidate the card. Therefore there is a need for systems and methods that enable a cardholder to establish flexible personal credit limits that may be modified contemporaneous with a cardholders varying need.

### SUMMARY OF THE INVENTION

A method for implementing a personal credit limit comprising providing a line of credit to a user, enabling the user to contact a holder of the line of credit, enrolling the user in a personal credit adjustment service program, providing a soft credit limit management software module accessible to the user after enrollment in the personal credit adjustment service program, setting a credit limit by the user, at an amount less than the line of credit, checking the user credit request against the set credit limit; and authorizing the credit request when the credit request does not result in the user exceeding the set credit limit or the line of credit.

A system for implementing a personal credit limit comprising a host interface for enabling a user to communicate with a holder of an established line of credit, a software module, configured to enable the user to enroll in a personal credit adjustment service program, a soft credit limit management software module accessible to the user, after enrollment in the personal credit adjustment service program, to enable the user to manage the user line of credit by setting a credit limit at an amount less than the user line of credit, a communication module to enable the holder of the established line of credit to communicate with the personal credit adjustment service program when the user requests to use the established line of credit, a credit check module for verifying available credit and authorizing the user credit request when the user credit request does not result in the user exceeding the established line of credit or the user line of credit limit.

### BRIEF DESCRIPTION OF THE DRAWINGS

Although the scope of the present invention is much broader than any particular embodiment, a detailed description of the preferred embodiment follows together with drawings. These drawings are for illustration purposes only and are not drawn to scale. Like numbers represent like features and components in the drawings. The invention may best be understood by reference to the ensuing detailed description in conjunction with the drawings in which:

FIG. 1 illustrates a diagram of an exemplary credit card budgeting system.

FIG. 2 illustrates a diagram of an exemplary embodiment of the present invention that shows a method for processing credit card information.

FIG. 3 illustrates a diagram of an exemplary embodiment of the present invention that shows another embodiment of a method for allowing a user to set a personal credit limit for a credit card using a web interface.

FIG. 4 illustrates a flowchart of an exemplary embodiment of the present invention depiction the major steps of a processing method.

### DETAILED DESCRIPTION OF THE INVENTION

In one embodiment of the present invention, the cardholder/consumer is able to access his/her account and select the desired amount for a particular day or a particular transaction from his/her available credit line balance. In such embodiment, the cardholder has chosen/selected amount at risk if his/her card is stolen, misplaced, or compromised. For example, when a transaction is conducted, the card allows only the most recently chosen/selected amount on his/her credit card.

As a further example, aspects of embodiments of the present invention provide greater control to the cardholder. For example, a cardholder that is attempting to maintain a budget, either voluntarily or involuntarily for example as a result of a Court Order or other Administrative proceeding, may set limits well below the credit limit to control spending or other behavior patterns. As a further example, a “gamblers anonymous program” can require the card holder to set limits below the credit limit of the card, prior to obtaining certification. As a further example, minors or college students whose parents co-sign on a credit card can set realistic limits on credit cards that are below the credit limit to control spending habits of their children. Thus, there is a need for a process allowing a cardholder to set a “use limit” below the credit limit of his/her card to provide added security and control of the card. Moreover, there is a need for this functionality to be available on mobile devices.

Other objects, advantages, and applications of the embodiments of the present invention will be made clear by the following detailed description of a preferred embodiment of the present invention.

### Credit Card Budgeting System

The embodiments of the present invention are described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as systems, methods or devices. The following detailed description should not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.” The term “coupled” implies that the elements may be directly connected together or may be coupled through one or more intervening elements. Further reference may be made to an embodiment where a component is implemented and multiple like or identical components are implemented.

While the embodiments make reference to a credit card and credit card limits, this is not intended to be a limitation of the embodiments of the present invention and such is equally applicable to any financial model where a user may desire to control access to funds, including but not limited to credit cards, personal signature loans, secured loans, and equity loans.

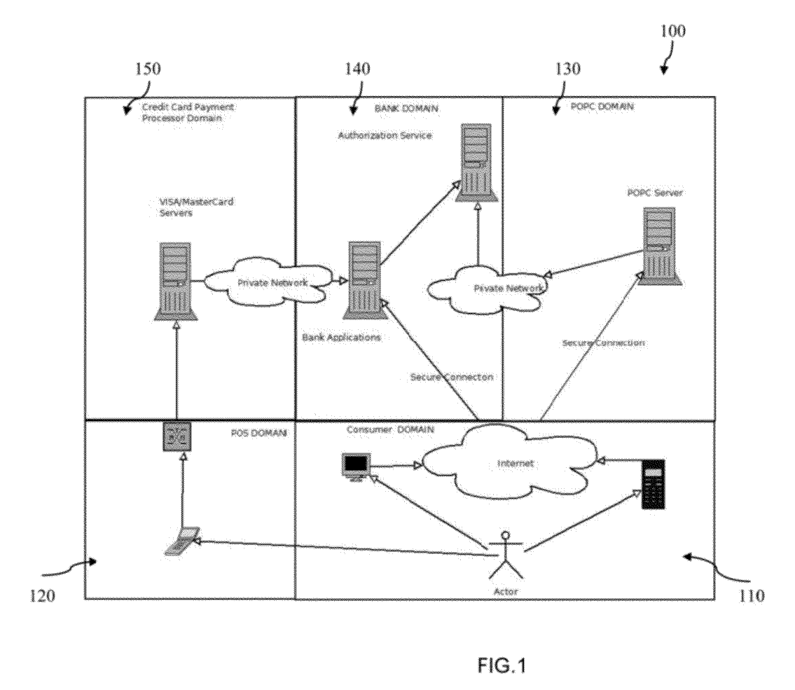

FIG. 1 depicts an exemplary credit card budgeting system 100. In one embodiment the system comprises five (5) domains: a consumer domain 110; a point of service domain 120; a protection of personal credit (POPC) 130; a bank domain 140; and a credit processing domain 150. The domains are coupled through various networks so that the domains may communicate among and with each other. In an embodiment, a user desiring to make a purchase at the POS domain 120 acts through the consumer domain 110, to communicate with and authorize the bank, acting through the bank domain 140 to allow a credit limit check of the users' credit line through the POPC domain 130. The user may have optionally set a personal credit limit, as described below, such limit would be stored at the POPC domain. To make a purchase, the user makes a credit request through the POS domain 120. The POS domain 120 communicates with the bank domain 140 to get transaction authorization, the bank domain 140 then communicates with the credit card payment processor domain 150. The credit card payment processor domain 150 communicates with the bank domain 140. If the bank domain authoirzes the credit, because the credit requested does not exceed the bank's credit limit for the user the bank domain then communicates with the POPC domain 130 to determine if the credit request is consistent with the user stored metrics at the POPC domain 130. If the credit is available the POPC domain 130 authorizes the credit request. Once the credit request is authorized the user is authorized to make a payment at the POS domain 120. If either the bank's preset credit limit or the POPC preset credit limit is exceeds, the transaction will not proceed.

In one embodiment of the present invention, there is an exemplary operating environment that comprises a credit card budgeting system that can be used to implement the methods disclosed herein. Embodiments of the credit card budgeting system generally includes a client device, one or more wired and/or wireless carrier systems, a land communications network, and a computer or a database. It should be understood that the disclosed method can be used with any number of different systems and is not specifically limited to the operating environment shown here. The architecture, construction, setup, and operation of the system and its individual components are generally known to those of skill in the art.

Aspects of the present invention may be implemented on one or more computers executing software instructions. According to one embodiment of the present invention, server and client computer systems transmit and receive data over a computer network or a fiber or copper-based telecommunications network (or any other communication medium). Accessing, downloading, and manipulating the data, as well as other aspects of the present invention are implemented by central processing units (CPU) in the server and client computers executing sequences of instructions stored in a memory. The memory may be random access memory (RAM), read-only memory (ROM), a persistent store, such as a mass storage device, or any combination of these devices. Execution of the sequences of instructions causes the CPU to perform functions according to embodiments of the present invention.

The instructions may be loaded into the memory of the server or client computers from a storage device or from one of more other computer systems over a network connection. For example, a client computer may transmit a sequence of instructions to the server computer in response to a message transmitted to the client over a network by the server. As the server receives the instructions over the network connection, it stores the instructions in memory. The server may store the instructions for later execution, or it may execute the instructions as they arrive over the network connection. In some cases, the instructions may not be directly executable by the CPU, and may instead be executed by an interpreter that interprets the instructions. In other embodiments, hardwired circuitry may be used in place of, or in combination with, software instructions to implement the present invention. Thus, embodiments of the present invention are not limited to any specific combination of hardware circuitry and software, nor to any particular source for the instructions executed by the server or client computers. In some instances, the client and server functionality may be implemented on a single computer platform.

Aspects of the present invention can be used in a distributed electronic commerce application that includes a client/server network system that links one or more server computers to one or more client computers. The client and server computers may be implemented as desktop personal computers, workstation computers, mobile computers, portable computing devices, personal digital assistant (PDA) devices, cellular telephones, digital audio or video playback devices, or any other similar type of computing device. For purposes of the following description, the terms “computer network” and “online” may be used interchangeably and do not imply a particular network embodiment or topography. In general, any type of network (e.g., LAN, WAN, Internet or any communication medium) may be used to implement the online or computer networked implementation of the software.

Aspects of the present invention may also include software products such as Operating Systems for—Windows (for PCs), for Apple, for Mobile (smartphones, tablets, and the like) and any computing system now existing or developed in the future. The software application deciphers cardholder's credit card related information and will access the consumer's respective credit card account at the related card company or bank, read client's credit line data, make it available to client to see and modify per his desire/requirement and update the credit card company or bank data. Embodiments of the present invention provide for the optional feature of giving the client the choice of setting selections, for example:
1. Setting of Transaction Limit/Daily Spending Limit/Trip Expense Limit/Monthly Purchase Limit.
2. Setting of Online Purchase Limit (OPL) options, such as Not Allowed; Online Purchase Transaction Limit; Maximum OPL.
3. Setting of the cash limit (i.e., cash that can be received by a customer from any participating merchant).

If the merchant (any participating ones) are willing to give cash to the consumer as set in the cash withdrawal limit set on the credit card (only allowable against the available credit line), both merchant as well as the participating banks can make/save money Banks can make money by saving on the large overheads that they incur on ATMs. If they adapt the “CASH” disbursement through the stores, the consumer will find the solution convenient as well as time saving. The Banks can pay a small fee to merchants for this service. Hence, both Banks and merchants will find it benefiting and will adapt it very easily. The Merchants will also get additional/special “Cash Flow and Credit Line” from the “Banks” which they will find a very attractive proposition.

In another embodiment, there is an encryption feature to encrypt the communication transaction information data for protection while the transaction is conducted over the Internet (accessing and interacting with the necessary Internet “Links” of the Credit Card issuing “Banks”. These applications may require the consumer to have a computer or smartphone as well as Internet access. For both of the above mentioned products, the user will need to take extra effort to learn and familiarize themselves with the procedures/steps to use these applications. The large market for these products is supplemented by an additional market where the consumer may take even fewer steps to benefit from these features/applications. For example, additional exemplary features such as
1. Credit Card Swipe (CCS)—with USB interface for PC (LT/DT/PDA).
2. Credit Card Swipe (CCS)—with connector interface for SmartPhones.

CCS—PC USB: This product may have the capability to connect to MUAZ POPC “MUAZ” is the name of a company and “POPC” stands for “protection of personal credit”. PC (personal computer) THE SOFTWARE APPLICATION. The follow-up steps may be performed through this software application on PC (LT/DT/PDA—WINDOW based), also (Apple OS based). This gadget/Dongle may be a basic version and will not have LCD display on it. Hence in one embodiment, all interactive activity to modify the desired Credit Card information (load Credit Card limit, set Cash desired limit, set transaction limit, set daily available Credit limit, set expense cap, etc) may all be carried out using the PC display.

CCS—CP: In one embodiment, the hardware product that may be developed to achieve the Credit Card Swipe and Data update using Cell Phones will activate MUAZ POPC-MP software on the Mobile Phone and may enable the user to conduct all interactive activity to modify the desired Credit Card information (load Credit Card limit, set Cash desired limit, set transaction limit, set daily available Credit limit, set expense cap, etc) update using the Cell Phone display.

The next two hardware products may have their own display screens in addition to the features of their predecessors. Here the convenience of display is added to provide more ease of use and mobility.

In another embodiment, the system enables a card reader to be integrated with or coupled to a computer or smartphone, enabling a credit card to be swiped. Further it may be an integrated device which is embedded in the computer or smartphone.

In embodiments which enable the local scanning or swiping of a credit card it is essential to have security in place to prevent fraud. To protect the credit card and other financial information transmission and reception and to authenticate the customer, hardware level security (specifically at the chip level within the hardware) is used between the POPC server and the POPC scanning device. This security allows protection from active snooping malware on the computer or smartphone, through the network or other devices connected to the network of credit information. It also authenticates that the authorized user is indeed communicating with the server.

Hardware interfaces that can be implemented between the credit card scanning system and the computing/communication devices that allow bi-directional communication exchange include but are not limited to USB Interfaces, speaker/microphone interfaces, and wifi interfaces (802.11)

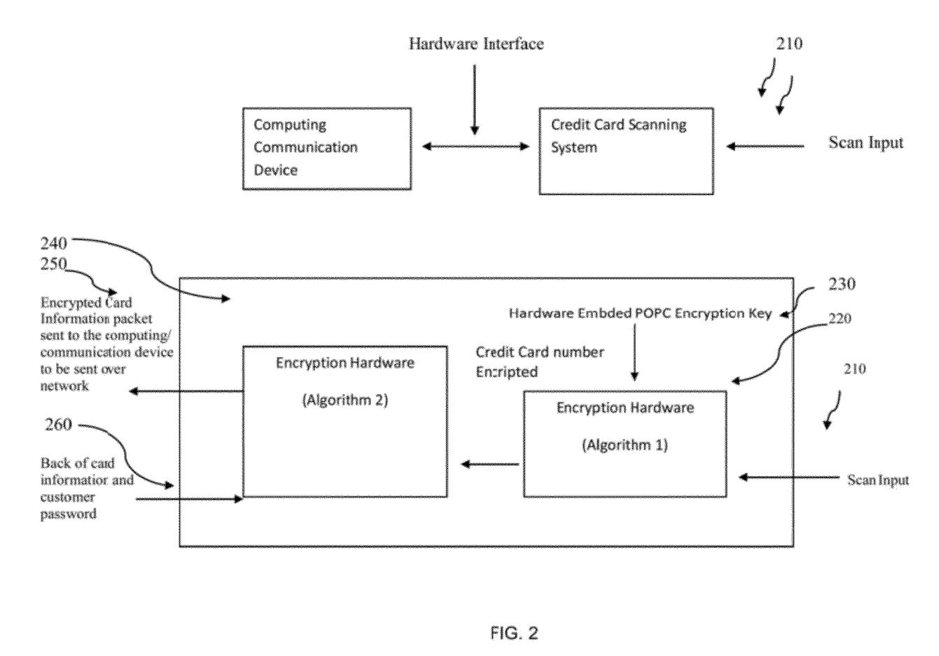

One embodiment of a method 200 for processing credit card information is depicted in FIG. 2. In order to process the credit card information the following occurs. A user begins by scanning a credit card to input scanned data 210. The scanned card number is encrypted using an algorithm in hardware 220 and the hardware waits for a timer period of 20 seconds to receive back of the card security code and the password from the POC client software 230. If this information is not received in 20 seconds, the user must re-swipe the credit card. Although 20 seconds is the preferred timeout period it is not intended to be a limitation on the embodiments or other time periods both shorter and longer are contemplated within the scope of the embodiment. Preferably the timeout is between 15 and 25 seconds. The encrypted credit card information is further encrypted with the back of the card security information 240 and sent over the network 250. The customer password and the resulting information is passed back to the client software 260 to be sent over the network which the software will send over the public network to the POPC server. In one embodiment, this information is inputted, in another embodiment, the information is transferred by scanning or “swiping” the card through the POPC hardware or any similar hardware/software combination. The POP Server performs the reverse process to extract the credit card information.

One embodiment of an encryption algorithm that may be implemented is an RSA. In such an embodiment, a key character, for example a 10 character long key, is stored in an EPROM in the scanning device. This EPROM can be programmed through the standard interface of the scanning device. The credit card is a 20 byte string (16 bytes for number and four bytes for the expiration date. The RSA algorithm then uses 10 character long secret key (decided by the financial institution and encrypts the 20 bytes to produce 20 bytes of encrypted card number information. This information is then forwarded to the second security block. The main purpose of this block is encrypted the credit card number so that un-encrypted card number never reaches even the computing/communication device. Although described in conjunction with a 10 character key length, the key length could be longer or shorter depending on the decided security strength and the exemplary length is not intended to be a limitation on the embodiments of the present invention.

The secondary encryption maybe for example a DSS encryption, DSS is used for digital signatures. Implementing this algorithm, results in a key being generated by appending the following to form a string. {TIME_STAMP, Back of the card code, user password, 10 character secret key}. The key is used to encrypt the 20 byte encrypted credit card number developed above and then append the digital signature to the encrypted number. The resulting packet then is given back to POPC client to be sent over the network.

Processing the credit information in this novel way has several benefits: un-encrypted credit card number is never ever seen by connected computing/communication device and can never be known due to its robust encryption; the user is always authenticated using the digital signature and any snooping device along the communication device and never modify it with corrupting the whole packet. The digital security signature is encrypted in the hardware. This authenticated to the POPC server that the user indeed initiated the transaction and can never deny that he did not.

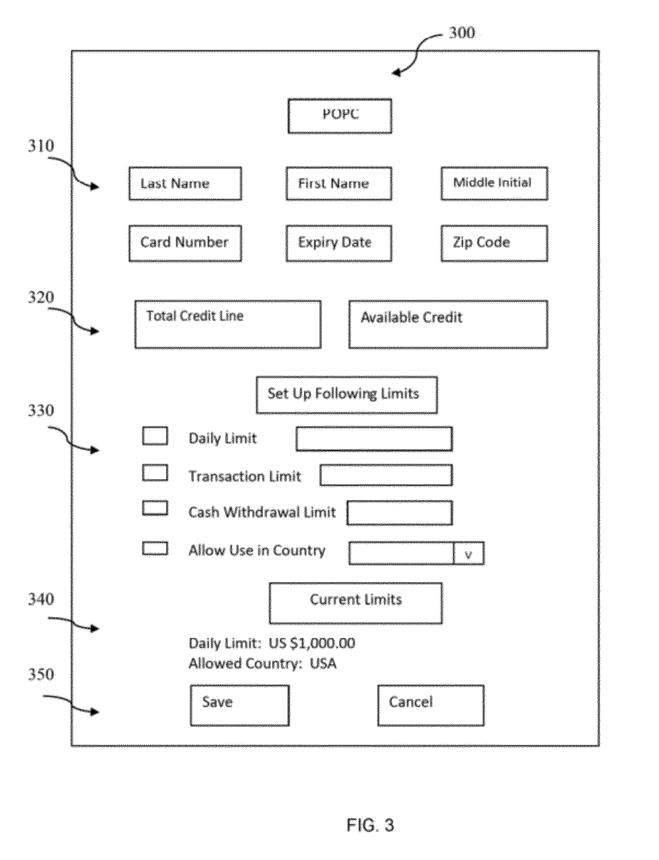

FIG. 3 depicts another embodiment of a method 300 for allowing a user to set a personal credit limit for a credit card using a web interface. The user begins by inputting personal identifiable information 310 including but not limited to name, address and/or zip code and credit card information including card number, expiration date, and security code. The system may then automatically populate the credit limit and available credit or it may be manually entered by the user 320. Once the information is input, the user is then requested to enter the limits the user wishes to establish 330, for example, daily, individual transaction limit, cash withdrawal limit, geographic region of use. The user may set only one limit or may set multiple limits. Once the information is input, a screen displaying he user established limits will be display 340, and the user will either confirm or cancel the limit setting request 350.

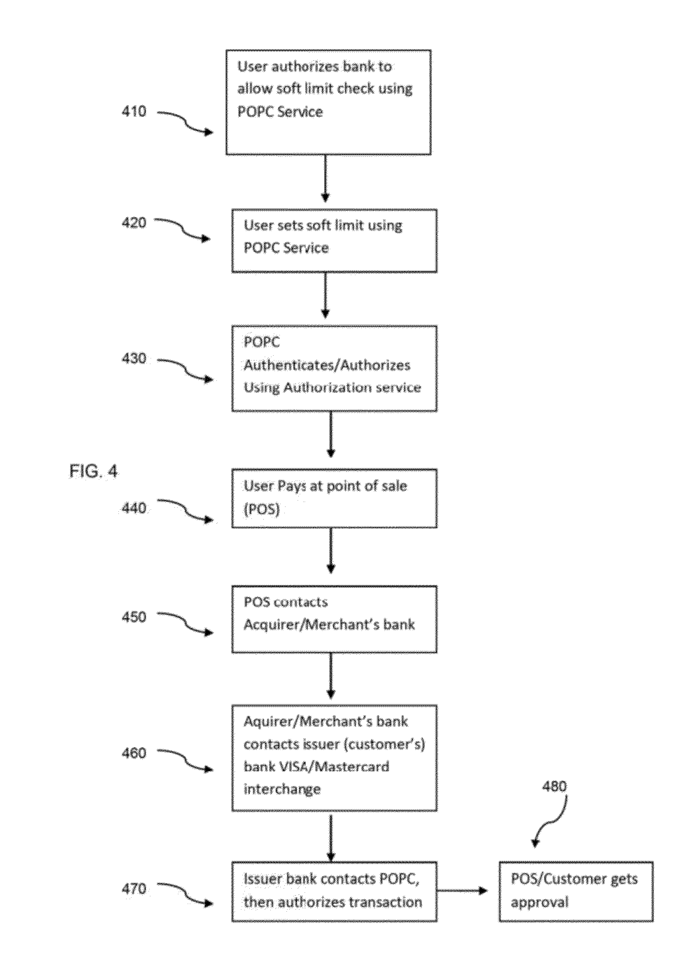

FIG. 4 illustrates a flowchart of an exemplary embodiment of the present invention depiction the major steps of the processing method. The order of the steps in the present embodiment is exemplary and is not intended to be a limitation on the embodiments of the present invention. It is contemplated that the present invention includes the process being practiced in other orders and/or with intermediary steps and/or processes. In exemplary step 410 a user may authorize a bank to allow soft limit check using POPC service. In exemplary step 420 a user may set a soft limit using POPC service. In exemplary step 430 POPC may authenticate or authorize using an authorization service. In exemplary step 440 a user may pay at a point of sale. In exemplary step 450 a POS may contact an acquirer or merchant's bank. In exemplary step 460 an acquirer or merchant's bank contacts an issuer's (in one embodiment the customer) bank VISA/MASTERCARD interchange. In exemplary step 470 an issuer bank contacts POPC then authorizes the transaction. In exemplary step 480 POS and/or customer obtains approval. As noted previously the forgoing descriptions of the specific embodiments are presented for purposes of illustration and description. They are not intended to be exhaustive or to limit the invention to the precise forms disclosed and obviously many modifications and variations are possible in view of the above teachings. The embodiments were chosen and described in order to explain the principles of the invention and its practical applications, to thereby enable those skilled in the art to best utilize the invention and various embodiments thereof as suited to the particular use contemplated. It is intended that the scope of the invention be defined by the claims and their equivalents.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions.

As used in this specification and claims, the terms “for example,” “for instance,” “such as,” and “like,” and the verbs “comprising,” “having,” “including,” and their other verb forms, when used in conjunction with a listing, of one or more components or other items, are each to be construed as open-ended, meaning that that the listing is not to be considered as excluding other, additional components or items. Other terms are to be construed using their broadest reasonable meaning unless they are used in a context that requires a different interpretation.

What is claimed is:

1. A method for implementing a personal credit limit comprising:
providing a line of credit to a user;
enabling the user to contact a holder of the line of credit;
enrolling the user in a personal credit adjustment service program providing a soft credit limit management software module accessible to the user after enrollment in the personal credit adjustment service program;
setting a credit limit by the user, at an amount less than the line of credit;
checking the user credit request against the set credit limit; and
authorizing the credit request when the credit request does not result in the user exceeding the set credit limit or the line of credit.

2. The method of claim 1 wherein the set credit limit is a daily credit limit.

3. The method of claim 2, wherein the daily limit is at the start of each day.

4. The method of claim 1, wherein setting the credit limit by a user is modifiable on demand.

5. The method of claim 1, wherein setting the credit limit by user is modifiable on a periodic basis.

6. A system for implementing a personal credit limit comprising:
an host interface for enabling a user to communicate with a holder of an established line of credit;
a software module, configured to enable the user to enroll in a personal credit adjustment service program;
a soft credit limit management software module accessible to the user, after enrollment in the personal credit adjustment service program, to enable the user to manage the user line of credit by setting a credit limit at an amount less than the user line of credit;
a communication module to enable the holder of the established line of credit to communicate with the personal credit adjustment service program when the user requests to use the established line of credit;
a credit check module for verifying available credit and authorizing the user credit request when the user credit request does not result in the user exceeding the established line of credit or the user line of credit limit.

7. The system of claim 6, wherein the interface is a graphic user interface.

8. The system of claim 6, wherein the interface is a voice-activated interface.

9. The system of claim six where in the interface is a credit card scanning system.
